(19) United States
(12) Patent Application Publication
(10) Pub. No.: US 2026/0088555 A1
(43) Pub. Date: Mar. 26, 2026

(54) CONNECTOR

(71) Applicant: SUMITOMO WIRING SYSTEMS, LTD., Mie (JP)

(72) Inventors: Akihisa OGAWA, Mie (JP); Hiroki OKANO, Mie (JP)

(21) Appl. No.: 19/328,644

(22) Filed: Sep. 15, 2025

(30) Foreign Application Priority Data
Sep. 20, 2024 (JP) 2024-164040

(51) Int. Cl. H01R 13/502

(52) U.S. Cl. CPC H01R 13/502

(57) ABSTRACT

A moving plate includes: a plate body whose plate surfaces face a front-rear direction, protruded portions protruding from the plate surfaces of the plate body, and through holes extending through the plate body and the protruded portions. Male terminal fittings include tabs that are inserted into the through holes. Settings are made such that leading ends of the tabs are accommodated in the through holes when the moving plate is at an initial position.

### CROSS-REFERENCE TO RELATED APPLICATIONS

This application is based on and claims priority from Japanese Patent Application No. 2024-164040, filed on Sep. 20, 2024, with the Japan Patent Office, the disclosure of which is incorporated herein in its entirety by reference.

### TECHNICAL FIELD

The present disclosure relates to a connector.

### BACKGROUND

A connecter disclosed in JP 2003-317870 A includes a male housing, male terminal fittings that are housed in the male housing, and a moving plate that is attached to the male housing. The male housing includes a tubular hood portion. The moving plate is disposed movably from a holding position to a holding release position inside the hood portion. Tabs of the male terminal fittings protrude inside the hood portion, and are inserted into tab through holes of the moving plate. When the moving plate is at the holding position, front end portions of the tabs are mated with and positioned by the tab through holes. Note that JP 2003-045572 A and JP 2004-265686 A can be cited as prior art related to the present disclosure in addition to JP 2003-317870 A.

### SUMMARY

In JP 2003-317870 A, when the moving plate is at the holding position, the leading ends of the tabs of the male terminal fittings protrude forward from the tab through holes. For this reason, there is a possibility that the leading end of a tab may interfere with an extraneous material entering from a front surface opening of the hood portion. In contrast, with a configuration in which the leading ends of the tabs are accommodated in the tab through holes, it is possible to avoid interference between the leading end of a tab and an extraneous material. However, even when the leading ends of the tabs are initially accommodated in the tab through holes, there is a possibility that the leading ends of the tabs will come loose from the tab through holes due to the assembly tolerance or the like for attaching the moving plate to the male housing or the assembly tolerance or the like for attaching the male terminal fittings to the male housing, or due to a rearward pulling force acting on the male terminal fittings.

In view of this, an object of the present disclosure is to provide a connector that can increase the reliability of protection of tabs.

A connector according to the present disclosure including: a housing body; male terminal fittings that are housed in the housing body; a tubular hood portion protruding forward beyond the housing body; and a moving plate that is movable rearward from an initial position to a mating position inside the hood portion, wherein the moving plate includes: a plate body whose plate surfaces face a front-rear direction; protruded portions protruding from at least one surface out of the plate surfaces of the plate body; and through holes extending through the plate body and the protruded portions, the male terminal fittings include tabs extending in the front-rear direction and are inserted into the through holes, and settings are made such that leading ends of the tabs are accommodated in the through holes when the moving plate is at the initial position.

According to the present disclosure, it is possible to provide a connector that can increase the reliability of protection of tabs.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to a first embodiment.

FIG. 2 is a front view of a partner connector that is a mating partner of the connector according to the first embodiment.

FIG. 3 is a front view showing a state where a lever is held at a mating start position relative to a male housing, in the connector according to the first embodiment.

FIG. 4 is an enlarged perspective view of a front surface portion of a housing body that includes receiving recessed portions and abutment portions, in the connector according to the first embodiment.

FIG. 5 is a perspective view of a moving plate in the connector according to the first embodiment, as viewed from the front.

FIG. 6 is a perspective view of the moving plate in the connector according to the first embodiment as viewed from the rear.

FIG. 7 is a rear view of the moving plate in the connector according to the first embodiment.

FIG. 8 is an enlarged front view showing a portion of a tab of a male terminal fitting that protrudes from a male cavity of the housing body, in the connector according to the first embodiment.

FIG. 9 is a cross-sectional side view showing a state where the moving plate is disposed at an initial position inside a hood portion, in the connector according to the first embodiment.

FIG. 10 is a cross-sectional side view showing a state where the connector according to the first embodiment and the partner connector are properly mated with each other, and the moving plate has reached a mating position.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure will be listed and described.

(1) A connector according to the present disclosure including: a housing body; male terminal fittings that are housed in the housing body; a tubular hood portion protruding forward beyond the housing body; and a moving plate that is movable rearward from an initial position to a mating position inside the hood portion, wherein the moving plate includes: a plate body whose plate surfaces face a front-rear direction; protruded portions protruding from at least one surface out of the plate surfaces of the plate body; and through holes extending through the plate body and the protruded portions, the male terminal fittings include tabs extending in the front-rear direction and are inserted into the through holes, and settings are made such that leading ends of the tabs are accommodated in the through holes when the moving plate is at the initial position.

With the configuration of above (1), it is possible to maintain a state where the leading ends of the tabs are accommodated in the through holes while the male terminal fittings are housed in the housing body, and increase the reliability of the moving plate protecting the tabs. Particularly, the length in the front-rear direction of the through holes can be increased by an amount corresponding to the protruded portions provided in the moving plate, compared with a case where the plate body is not provided with such protruded portions, and thus it is possible to reliably realize a state where the leading ends of the tabs are always accommodated in the through holes.

(2) In the connector according to the above (1), it is preferable that the plate body has a shape that is longer in a left-right direction than in an up-down direction, a plurality of the through holes are aligned vertically and laterally in front view and rear view of the plate body, and the protruded portions are provided in correspondence with at least through holes aligned in the left-right direction in a vertical intermediate portion of the plate body, from among the plurality of through holes.

With the configuration of above (2), the vertical intermediate portion of the plate body can be made thick by the protruded portions. For example, it is possible to prevent a lateral intermediate portion of the plate body from bulging as a result of warping and deforming in a high-temperature environment or the like. In addition, it is possible to increase a region in which the leading ends of the tabs are supported.

(3) In the connector according to above (2), the protruded portions may include portions continuously extending in the left-right direction to couple adjacent through holes.

With the configuration of above (3), the thickness in the vertical intermediate portion of the plate body can be further increased by the protruded portions.

(4) In the connector according to any one of above (1) to (3), it is preferable that the protruded portions include rear protruded portions protruding from a rear surface of the plate body, and a front surface of the housing body includes receiving recessed portions that are mated with the rear protruded portions when the moving body is at the mating position.

With the configuration of above (4), even when the leading ends of the tabs retract inside the through holes, the leading ends of the tabs can remain at the rear protruded portions. Particularly, the distance between the front surface of the housing body and a connection partner, namely the female housing does not increase because the rear protruded portions are mated with the receiving recessed portions when the plate body is at the mating position, and thus it is possible to satisfy effective contact length between the male terminal fittings and the female terminal fittings.

(5) In the connector according to above (4), the housing body may include: male cavities that house the male terminal fittings and abutment portions provided on a front surface side of the housing body, the male terminal fittings may include abutted portions that oppose the abutment portions from the rear in a state of being housed in the male cavities, each of the abutment portions may be provided at a portion in a circumferential direction of an opening edge portion of the male cavity in the front surface of the housing body, and each of the receiving recessed portions may be provided at another portion in the circumferential direction of the opening edge portion of the male cavity in the front surface of the housing body.

With the configuration of above (5), the abutment portion can suppress forward movement of the male terminal fitting housed in the male cavity. Particularly, the receiving recessed portion and the abutment portion are formed by dividing the opening edge portion of the male cavity in the circumferential direction, and thus, the rear protruded portion can be mated with the receiving recessed portion without changing the housing position of the male terminal fitting in the front-rear direction from the existing position. In addition, the receiving recessed portion and the abutment portion can be formed on the front surface side of the housing body in a space-efficient manner.

### Details of Embodiments of the Present Disclosure

Specific examples of the present disclosure will be described below with reference to the drawings. Note that the present invention is not limited to these examples, but rather is indicated by the claims, and is intended to include all modifications that are within the meanings and the scope that are equivalent to those of the claims.

### First Embodiment

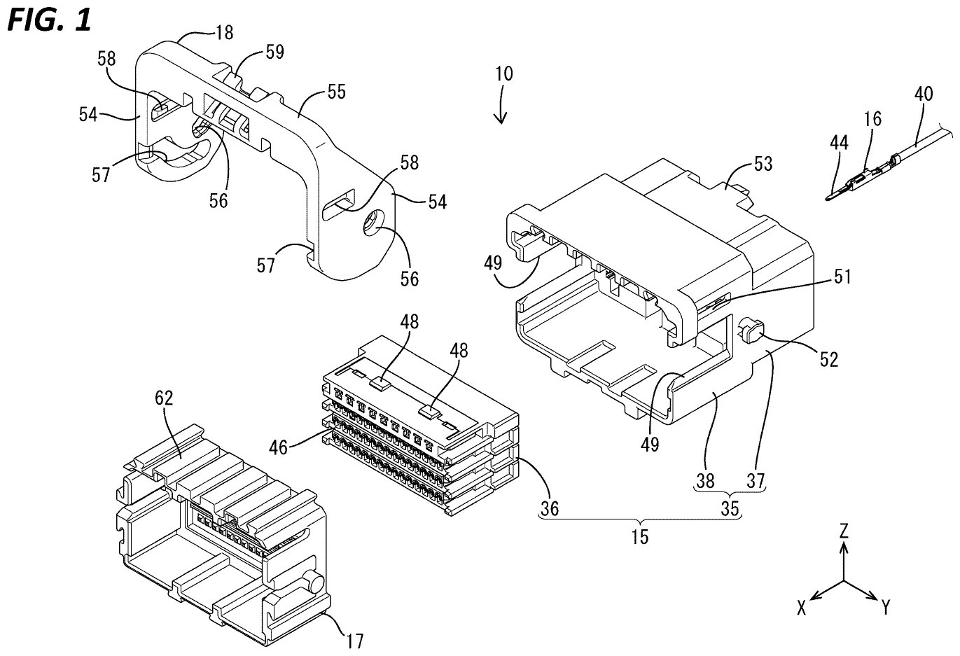

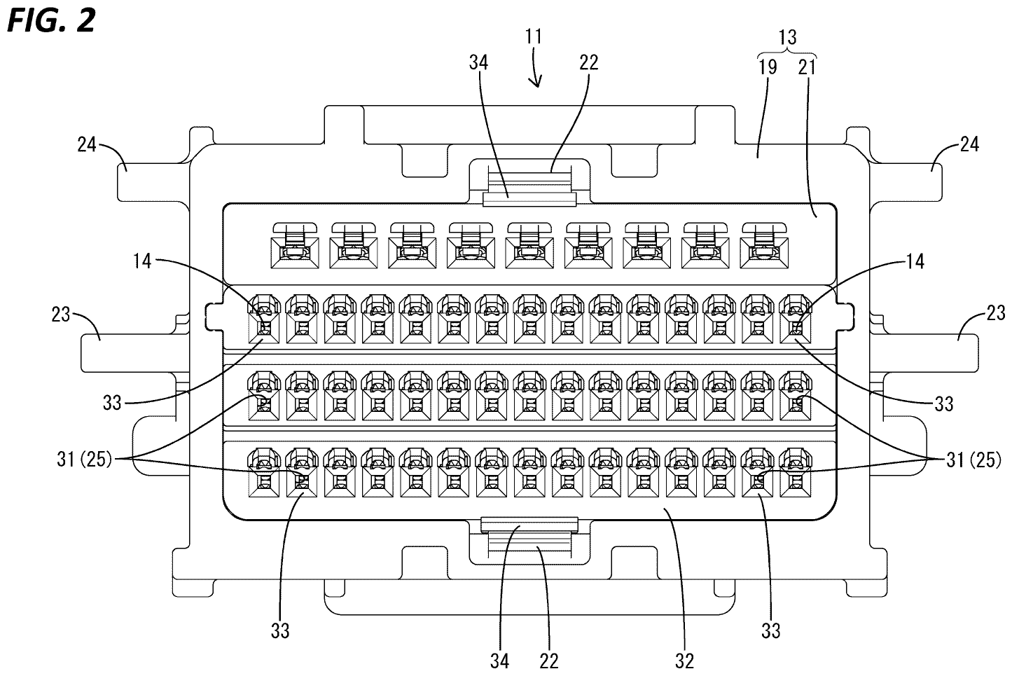

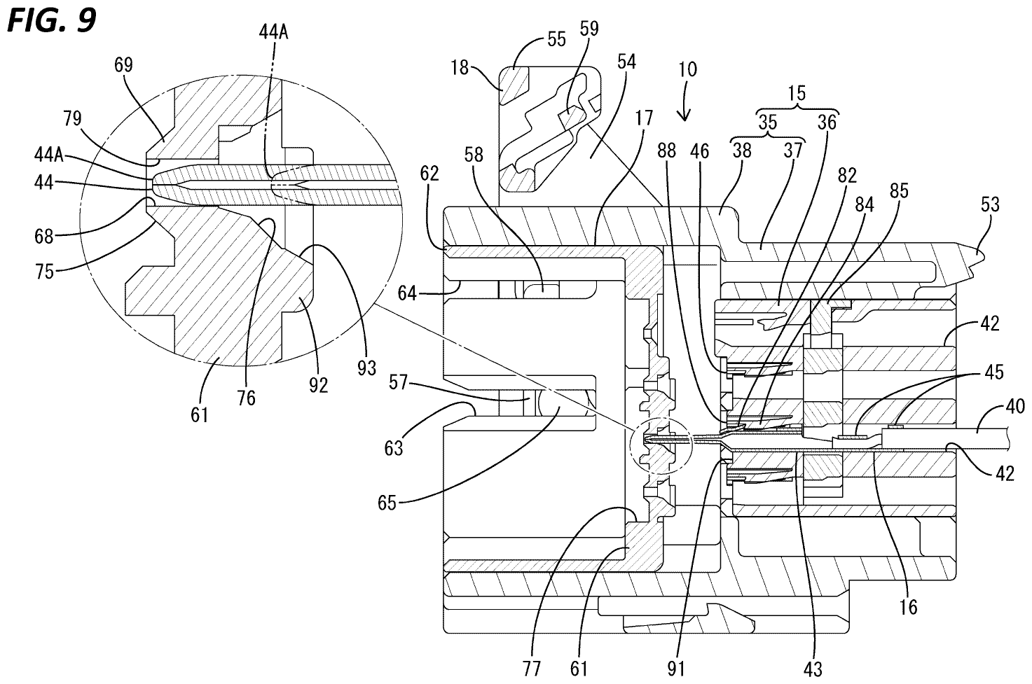

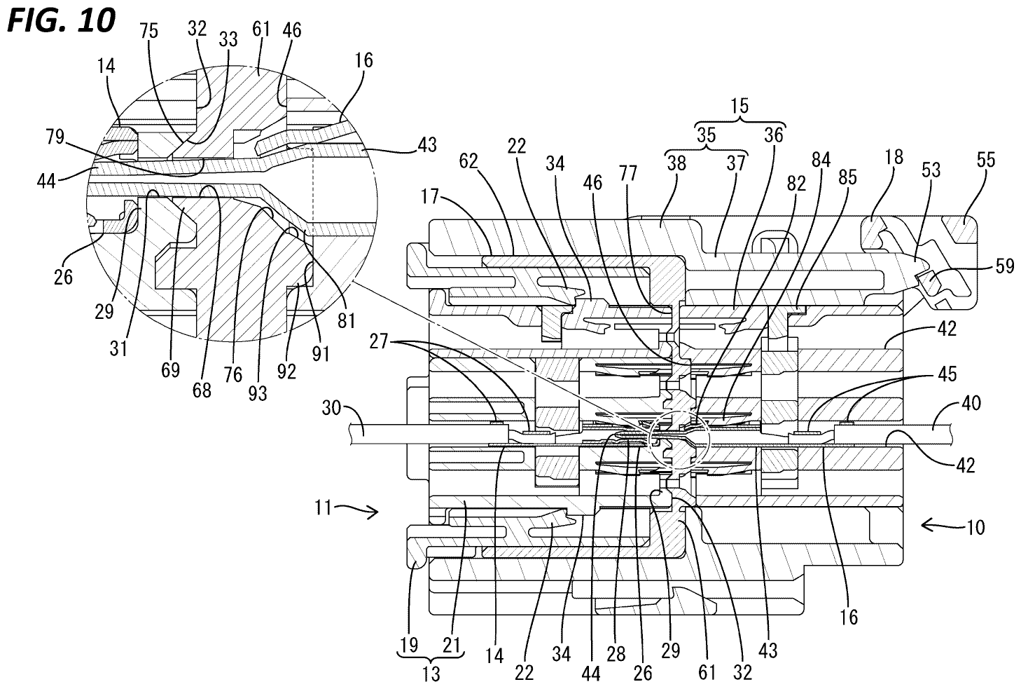

As shown in FIGS. 1 and 9, a connector 10 according to a first embodiment of the present disclosure includes a male housing 15, a plurality of male terminal fittings 16 (only one is shown in FIG. 1) that are housed in the male housing 15, a moving plate 17 that is movably disposed in the male housing 15, and a lever 18 that is rotatably supported by the male housing 15. The connector 10 is capable of mating with a partner connector 11. As shown in FIGS. 2 and 10, the partner connector 11 includes a female housing 13 and a plurality of female terminal fittings 14 that are housed in the female housing 13. Note that, in the following description, in the front-rear direction, the direction in which the connector 10 and the partner connector 11 are mated with each other is defined as a forward direction. The up-down direction is based on the up-down direction in the figures, and the left-right direction is based on the left-right direction when viewed from the front. In FIG. 1, the arrows X, Y, and Z indicate the forward, rightward, and upward directions, respectively. Such bases for directions are set for convenience and do not necessarily match a basis for a direction in a state where the connector 10 is mounted in a vehicle or the like (not shown).

### Partner Connector 11

The female housing 13 is made of a synthetic resin. In the first embodiment, as shown in FIG. 2, the female housing 13 is constituted by a female frame 19 and a female inner housing 21 that is housed in the female frame 19. The female frame 19 has the shape of a rectangular case that is longer in the left-right direction than in the up-down direction. A pair of upper and lower female lock portions 22 are formed to respectively protrude from the upper and lower inner surfaces of the female frame 19. A pair of left and right housing-side cam pins 23 are formed to protrude from vertical intermediate portions of the left and right outer surfaces of the female frame 19. The housing-side cam pins 23 protrude, while extending in the front-rear direction in the shape of ribs, on the left and right outer surfaces of the female frame 19. The housing-side cam pins 23 can be inserted into cam grooves 57 of the lever 18 to be described later, in a state of being joined with plate-side cam pins 65 to be described later, respectively. A pair of left and right unlocking portions 24 are formed to protrude from upper end portions of the left and right outer surfaces of the female frame 19. The unlocking portions 24 unlock later-described initial lock portions 58 of the lever 18 and the male housing 15 from each other in a mating process of the connector 10 and the partner connector 11.

The female inner housing 21 is formed in a rectangular block shape, and has a plurality of female cavities 25 extending in the front-rear direction as shown in FIG. 10. The female terminal fittings 14 are inserted into and housed in the corresponding female cavities 25 from the rear of the female inner housing 21.

Each of the female terminal fittings 14 is made of a conductive metal, and, as shown in FIG. 10, includes a tubular connection portion 26 that is elongated in the front-rear direction, and a female barrel portion 27 that is continuous with the rear of the connection portion 26. The connection portion 26 is electrically connected to a male terminal fitting 16 by bringing an elastic contact piece 28, which is disposed inside the connection portion 26, into contact with a tab 44 of the male terminal fitting 16 to be described later. The female barrel portion 27 is electrically and mechanically connected to a terminal portion of an electric wire 30 by being crimped thereto.

As shown in FIG. 10, the female inner housing 21 has a front wall 29 for stopping the female terminal fittings 14 on the front side. The front wall 29 has a plurality of tab insertion holes 31 extending therethrough in the front-rear direction. The front surface of the front wall 29 of the female inner housing 21 serves as a female mating surface 32. The female mating surface 32 faces the front surface of a plate body 61 of the moving plate 17, which will be described later, in a contactable manner when the connector 10 and the partner connector 11 are mated with each other. The tab insertion holes 31 of the respective female cavities 25 are open in the female mating surface 32, in multiple levels in the up-down direction and multiple rows in the left-right direction. The female mating surface 32 of the female inner housing 21 includes opening peripheral surface portions 33 in the opening edge portions of the tab insertion holes 31 of the female cavities 25. On upper, lower, left, and right edge portions (the four side portions, namely, the entire peripheral portion) that are opening edge portions of each of the female cavities 25, opening peripheral surface portions 33 are formed as inclined surfaces each having a tapered shape, expanding toward the front where a front protruded portion 69 to be described later is positioned.

As shown in FIGS. 2 and 10, the female inner housing 21 includes a plurality of female lock receiving portions 34 that can be locked with the respective female lock portions 22. The female lock receiving portions 34 protrude from lateral intermediate portions of the upper and lower outer surfaces of the female inner housing 21. As shown in FIG. 10, the female inner housing 21 is held in place inside the female frame 19 by locking the female lock receiving portions 34 with the respective female lock portions 22.

### Male Housing 15, Male Terminal Fittings 16, and Lever 18

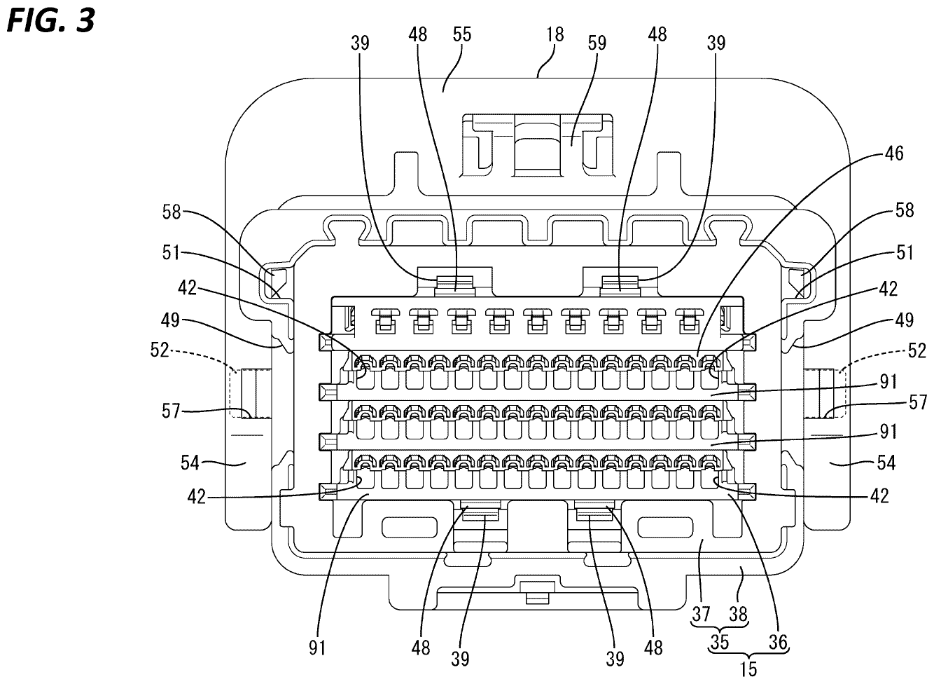

The male housing 15 is made of a synthetic resin. In the first embodiment, as shown in FIG. 3, the male housing 15 is constituted by a male frame 35 and a housing body 36 serving as a male inner housing that is housed in the male frame 35. As shown in FIG. 1, the male frame 35 has the overall shape of a rectangular case that is longer in the left-right direction than in the up-down direction and is open in the front-rear direction. The male frame 35 includes a frame body 37 and a hood portion 38 that protrudes forward from the frame body 37.

As shown in FIG. 3, the frame body 37 includes a pair of left and right male lock portions 39 on both the upper and lower sides. The male lock portions 39 protrude from both the upper and lower inner surfaces of the male frame 35, spaced apart in the left-right direction. The male lock portions 39 are elastically deformable in the up-down direction.

The housing body 36 has the shape of a rectangular block, and has a plurality of male cavities 42. As shown in FIGS. 9 and 10, elastically deformable lances 84 that protrude to the inside of the respective male cavities 42 from the upper surfaces of the inner walls of the male cavities 42 are formed in the housing body 36. The male terminal fittings 16 are inserted into the corresponding male cavities 42 from the rear of the housing body 36.

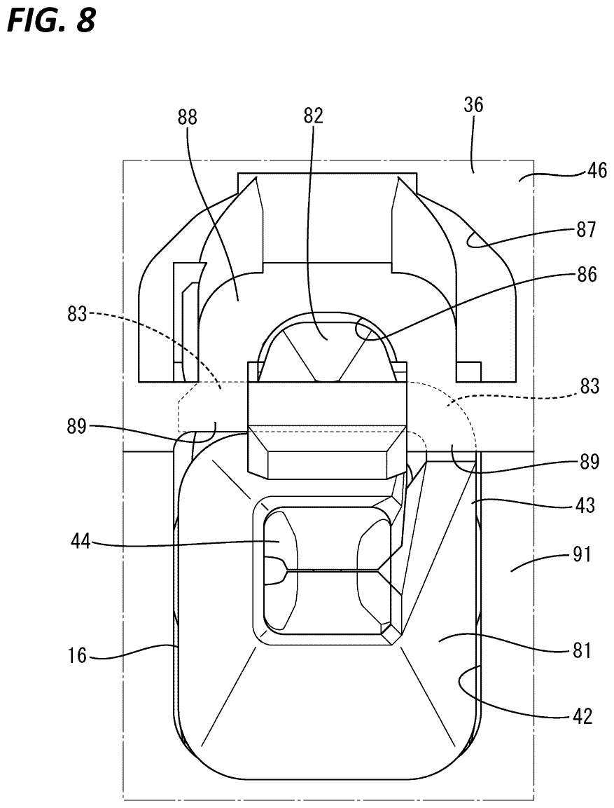

The male terminal fittings 16 are formed by performing a bending process or the like on conductive metal plates. Each of the male terminal fittings 16 includes a tubular male terminal body 43, the tab 44 that protrudes forward from the male terminal body 43, and a male barrel portion 45 continuous with and rearward of the male terminal body 43. The male barrel portion 45 is electrically and mechanically connected to a terminal portion of an electric wire 40 by being crimped thereto. As shown in FIGS. 8 and 10, a narrowing portion 81 that tapers toward the tab 44 is formed at the front end portion of the male terminal body 43.

As shown in FIG. 8, the upper wall of the male terminal body 43 has a double-wall structure in which wall portions are arranged in the up-down direction (see FIGS. 9 and 10 showing an upper wall portion that includes a locking protrusion 82 to be described later, and a lower wall portion located below the upper wall portion). The locking protrusion 82 having an upwardly bulging shape is provided in a lateral intermediate portion of the upper wall portion of the double-wall structure of the upper wall of the male terminal body 43, and a pair of abutted portions 83 are provided at left and right end portions of the upper wall portion. The abutted portions 83 are plate thickness surfaces of the upper wall portion and face forward. The abutted portions 83 are disposed on left and right sides of the locking protrusion 82, forward of the locking protrusion 82.

As shown in FIGS. 9 and 10, each male terminal fitting 16 is housed in the male cavity 42 and the locking protrusion 82 is locked with the lance 84, and thus, the male terminal fitting 16 is primarily prevented from coming loose rearward from the housing body 36. In addition, the male terminal body 43 is locked with a retainer 85 mounted to the housing body 36, and thus, the male terminal fitting 16 is secondarily prevented from coming loose. Furthermore, the abutted portions 83 abut on later-described abutment portions 89 of the housing body 36 from the rear, and thus, the male terminal fitting 16 is prevented from coming loose forward from the housing body 36.

As shown in FIGS. 3, 9, and 10, the front surface of the housing body 36 (surface facing the front) is configured as a male mating surface 46. The male mating surface 46 of the housing body 36 corresponds to the back surface of the hood portion 38 and is disposed to face the front. As shown in FIG. 10, the male mating surface 46 of the housing body 36 can come into contact with the rear surface of the plate body 61 of the moving plate 17 when the connector 10 and the partner connector 11 are properly mated. As shown in FIG. 3, the male cavities 42 are open in the male mating surface 46, in multiple levels in the up-down direction and multiple rows in the left-right direction.

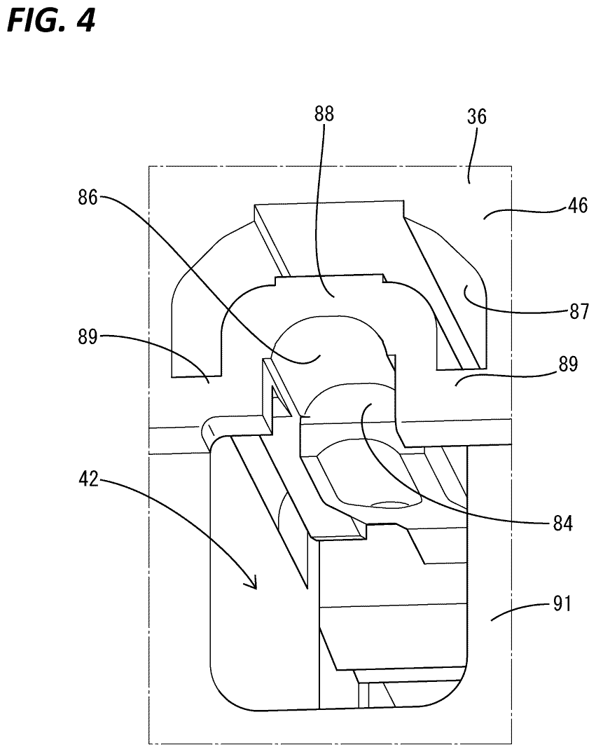

As shown in FIG. 4, a mold removal hole 86, which resulted from pulling off a mold (not shown) for forming a locking surface of the lance 84 (a surface that opposes the locking protrusion 82 of the male terminal fitting 16 and capable of locking therewith) is provided in a front end upper portion of each male cavity 42 of the housing body 36. The mold removal hole 86 in a semicircular shape is open in the male mating surface 46 of the housing body 36. The locking surface of the lance 84 is open to the front through the mold removal hole 86 in a visually recognizable manner. In addition, the housing body 36 has, above the mold removal hole 86, a flexible space portion 87 that allows elastic deformation of the lance 84. The flexible space portion 87 in a semicircular arc shape is open in the male mating surface 46 of the housing body 36.

The lance 84 includes a lance leading end portion 88 extending in the front-rear direction between the mold removal hole 86 and the flexible space portion 87. The lance leading end portion 88 is formed continuously in a gate-like shape, while being shaped as a semicircular arc in front view. The front surface of the lance leading end portion 88 forms a portion of the male mating surface 46 of the housing body 36. The housing body 36 includes a pair of abutment portions 89 extending a short distance in the left-right direction, between a front end portion of the lance leading end portion 88 and upper end portions of the left and right side surfaces of the male cavity 42. The abutment portions 89 are disposed on the left and right sides of the lance 84, forward of the locking surface of the lance 84. The front surfaces of the abutment portions 89 are continuous with the front surface of the lance leading end portion 88 with no difference in level, and form a portion of the male mating surface 46 of the housing body 36. Although not illustrated, the rear surfaces of the abutment portions 89 are arranged along the up-down direction and the left-right direction, and can face and abut on the corresponding abutted portions 83 of the male terminal fitting 16.

As shown in FIG. 3, on the front surface of the housing body 36, receiving recessed portions 91 are provided in a recessed manner in portions of opening edge portions of the respective male cavities 42 excluding upper end portions. As shown in FIG. 3, the receiving recessed portions 91 extend in the left-right direction in a continuous manner across the male cavities 42 aligned in the left-right direction, and are open to the left and right outer sides of the housing body 36. The receiving recessed portions 91 are arranged in multiple levels (three vertical levels) in correspondence with the male cavities 42 in the lower three levels that include a vertical intermediate portion, from among the male cavities 42 aligned in the up-down direction. As shown in FIG. 4, the upper end of each receiving recessed portion 91 is partitioned by the abutment portions 89 at positions corresponding to the male cavities 42. As shown in FIG. 3, the lower ends of the receiving recessed portions 91 are positioned below the male cavities 42, are open in the lower surfaces of divided housings that constitute the housing body 36, and are each partitioned by an adjacent lower divided housing or the frame body 37. As shown in FIG. 10, a later-described rear protruded portions 92 of the moving plate 17 can be mated with the receiving recessed portions 91.

As shown in FIGS. 1 and 3, the housing body 36 includes a plurality of male lock receiving portions 48 capable of locking with the respective male lock portions 39. The male lock receiving portions 48 protrude from lateral intermediate portions of both the upper and lower outer surfaces of the housing body 36 (only those formed on the upper outer surface are shown in FIG. 1), and are spaced apart from each other in the left-right direction. As shown in FIGS. 9 and 10, the housing body 36 is held inside the male frame 35 by locking the male lock portions 39 with the respective male lock receiving portions 48.

As shown in FIGS. 1 and 3, the male frame 35 includes a pair of left and right notch recessed portions 49 at vertical intermediate portions of the left and right walls of the hood portion 38. The notch recessed portions 49 extend in the front-rear direction and are open to the front of the hood portion 38. Left and right protruded portions of a peripheral wall portion 62 of the moving plate 17, which will be described later, are mated with the respective notch recessed portions 49. The male frame 35 includes a pair of left and right locking recessed portions 51 at positions above the respective notch recessed portions 49 in the left and right side walls of the hood portion 38. The locking recessed portions 51 each have the shape of a slit extending in the front-rear direction and are open to the front of the hood portion 38. As shown in FIG. 3, when the lever 18 is at the mating start position, the initial lock portions 58 of the lever 18 are locked with the inner surfaces of the respective locking recessed portions 51.

The male frame 35 includes a pair of support shafts 52 protruding laterally outward from the rear ends of the left and right side walls of the hood portion 38. The support shafts 52 rotatably support the lever 18. The male frame 35 has a lever lock portion 53 on the upper wall of the frame body 37. The lever lock portion 53 protrudes from a lateral intermediate portion of a rear end portion of the upper wall of the frame body 37. As shown in FIG. 10, the lever 18 can be locked with the lever lock portion 53 at a mating completion position to be described later.

The lever 18 is made of a synthetic resin, and, as shown in FIGS. 1 and 3, has an overall gate-like shape. Specifically, the lever 18 includes a pair of left and right cam plate portions 54 and an operation portion 55 that extends in the left-right direction and is coupled to the cam plate portions 54. The lever 18 has a lock arm 59 at a lateral intermediate portion of the operation portion 55. The lever 18 is mounted to the male frame 35 in such a manner as to straddle it from above. The cam plate portions 54 have shaft holes 56 into which the support shafts 52 are fitted, respectively. Cam grooves 57 are provided in a recessed manner in the inner surfaces (surfaces facing each other) of the respective cam plate portions 54. In addition, the elastically deformable initial lock portions 58 are respectively formed in the cam plate portions 54.

The lever 18 is rotatable about the support shafts 52 relative to the male frame 35 between a mating start position (see FIGS. 3 and 9) and the mating completion position (see FIG. 10), with the support shafts 52 being respectively fitted into the shaft holes 56. The lever 18 is held at the mating start position, on the male housing 15, by the initial lock portions 58 locking the inner surfaces of the locking recessed portions 51 of the male frame 35 as shown in FIG. 3.

### Moving Plate 17

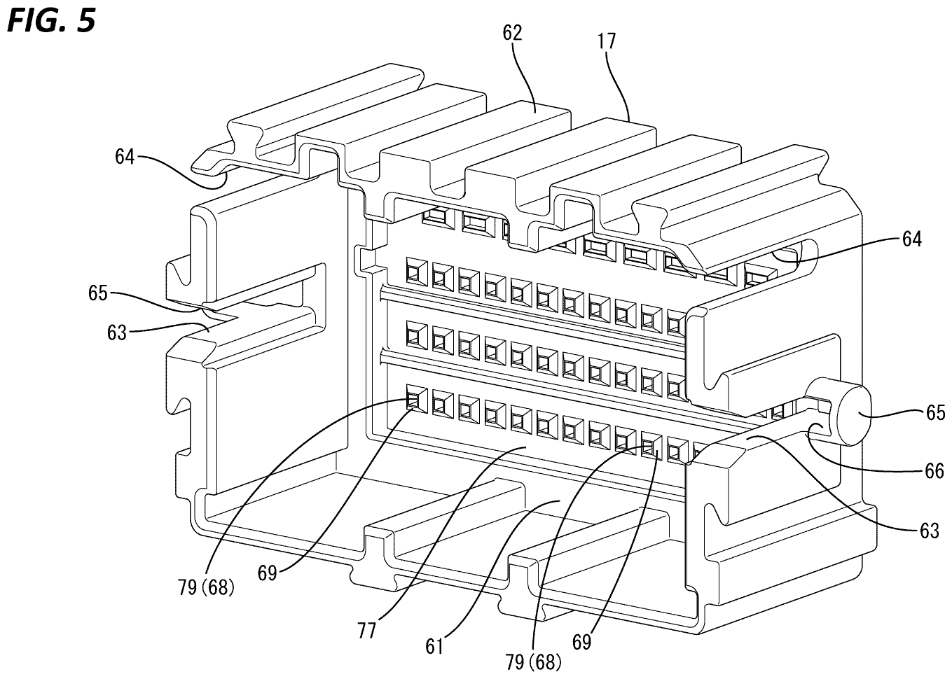

The moving plate 17 is made of a synthetic resin, and includes the flat plate body 61 whose plate surfaces face the front-rear direction, and the peripheral wall portion 62 having the shape of a rectangular tube and protruding forward from the plate body 61, as shown in FIGS. 5 to 7. As shown in FIG. 9, in a state where the moving plate 17 is disposed inside the hood portion 38, the plate body 61 is disposed forward of the male mating surface 46 of the housing body 36, and the peripheral wall portion 62 faces the inner peripheral surface of the hood portion 38 in a contactable manner.

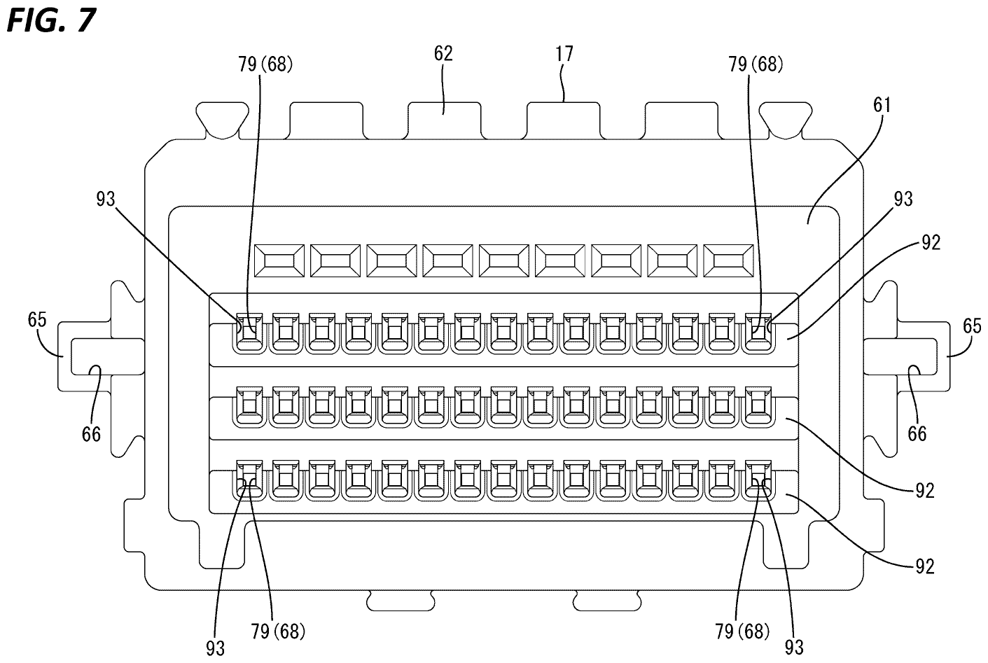

As shown in FIGS. 5 and 7, the peripheral wall portion 62 has a pair of left and right introduction recessed portions 63 at vertical intermediate portions of the left and right side walls. The introduction recessed portions 63 extend in the front-rear direction and are open to the front of the peripheral wall portion 62. In the mating process of the connector 10 and the partner connector 11, the housing-side cam pins 23 of the female housing 13 are respectively inserted into the introduction recessed portions 63. The peripheral wall portion 62 has a pair of left and right through recessed portions 64, at upper end portions of the left and right side walls. The through recessed portions 64 each have the shape of a slit extending in the front-rear direction, and are open to the front of the peripheral wall portion 62. The through recessed portions 64 are in communication with the respective locking recessed portions 51 of the male frame 35 (see FIG. 3) and are arranged in such a manner as to be able to receive the respective unlocking portions 24 of the female housing 13.

In addition, the peripheral wall portion 62 has a pair of left and right plate-side cam pins 65 rearward of the introduction recessed portions 63, in vertical intermediate portions of the outer surfaces of the left and right side walls. The plate-side cam pins 65 have a gate-like shape, which is circular in side view. Receiving holes 66 are formed to extend through the respective plate-side cam pins 65 in the front-rear direction. The receiving holes 66 of the plate-side cam pins 65 are disposed in communication with the respective introduction recessed portions 63. The housing-side cam pins 23 of the female housing 13 are mated with the receiving holes 66 through the introduction recessed portions 63, to be joined with the plate-side cam pins 65, respectively.

As shown in FIGS. 5 to 7, the plate body 61 has a rectangular shape that is longer in the left-right direction than in the up-down direction in front view or rear view. A plurality of through holes 68 are formed to extend through the plate body 61 in the front-rear direction (the plate thickness direction). The tabs 44 of the male terminal fittings 16 are respectively inserted into the through holes 68 from the rear. The through holes 68 are each shaped as an opening having a rectangular cross-section corresponding to the tab 44. In the plate body 61, the through holes 68 are arranged in multiple levels in the up-down direction and multiple rows in the left-right direction. As shown in FIGS. 9 and 10, the through holes 68 include straight hole portions 79 that linearly extend from later-described front protruded portions 69, respectively, to the plate body 61.

As shown in FIG. 5, a mating recessed portion 77 is provided in a recessed manner in an intermediate portion (excluding an outer peripheral region) of the front surface of the plate body 61. As shown in FIG. 10, a front end portion of the female inner housing 21 including the female mating surface 32 is mated with the mating recessed portion 77 of the plate body 61. In the first embodiment, in the moving plate 17, a plurality of protruded portions 69 and 92 protrude from the front surface (back surface of the mating recessed portion 77) and the rear surface of the plate body 61. The protruded portions 69 and 92 are composed of a plurality of front protruded portions 69 protruding from the front surface of the plate body 61 and a plurality of rear protruded portions 92 protruding from the rear surface of the plate body 61.

As shown in FIG. 5, the front protruded portions 69 are respectively formed for the corresponding through holes 68. Accordingly, adjacent front protruded portions 69 are spaced apart from each other. The front protruded portions 69 are provided in correspondence with all of the through holes 68 (including through holes 68 aligned in the left-right direction in a vertical intermediate portion). The straight hole portions 79 are formed to extend through the respective front protruded portions 69. Each of the front protruded portions 69 surrounds the straight hole portion 79 over the entire periphery thereof. Inclined surface portions 75 that taper toward the front are formed on the outer surfaces (peripheral surfaces) of the front protruded portion 69 as shown in FIGS. 9 and 10. As shown in FIG. 10, the inclination angle of the inclined surface portions 75 relative to the front-rear direction is the same as or approximate to the inclination angle of the opening peripheral surface portions 33 relative to the front-rear direction. When the connector 10 and the partner connector 11 are mated with each other, the inclined surface portions 75 of the front protruded portions 69 can be aligned with and face the opening peripheral surface portions 33 of the female housing 13, respectively, in a state of surface contact.

As shown in FIGS. 9 and 10, on the moving plate 17, expansion inclined surface portions 76 expanding toward the rear while each having a tapered shape are provided on the rear end opening edge portions of the through holes 68, which are continuous with the straight hole portions 79. On the rear surface side of the plate body 61, the expansion inclined surface portions 76 are respectively formed on the upper, lower, left, and right edge portions of each through hole 68 (the four side portions that make up the rear end opening edge portion) to cover the entire periphery of the through hole 68.

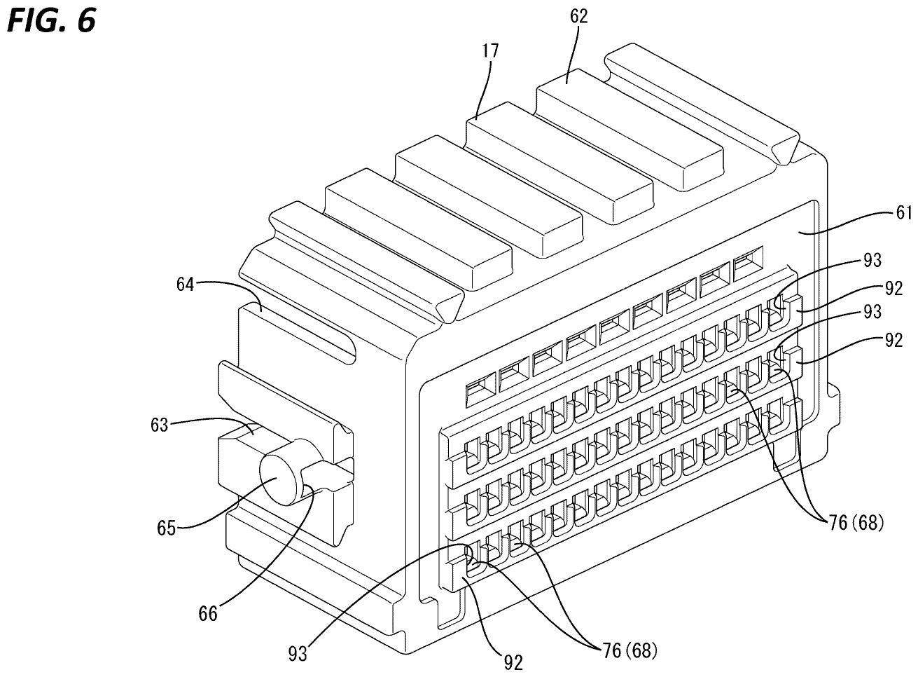

As shown in FIGS. 6 and 7, on the rear surface of the plate body 61, the rear protruded portions 92 are arranged in multiple levels (three vertical levels) in correspondence with the through holes 68 in the lower three levels that include a vertical intermediate portion. The rear protruded portions 92 are formed as ribs extending in the left-right direction in a continuous manner across the through holes 68 aligned in the left-right direction. The rear protruded portions 92 each include a recess portion 93 having a U-shape in rear view and partitioning portions of rear end opening edge portions of the through hole 68 excluding the upper end portion. In the rear protruded portions 92 of each level, a plurality of recess portions 93 are formed to be aligned in the left-right direction in correspondence with the through holes 68 aligned in the left-right direction. As shown in FIGS. 9 and 10, a rear end portion of each expansion inclined surface portion 76 forms an inner periphery surface of the recess portion 93, and expands toward the rear surface of the rear protruded portion 92 while being formed as a tapered shape. As shown in FIG. 10, when the connector 10 and the partner connector 11 are properly mated with each other, the narrowing portions 81 of the male terminal fittings 16 are disposed inside the recess portions 93, while opposing and extending along the expansion inclined surface portions 76.

### Operations of Connector 10

Prior to mating the connector 10 and the partner connector 11 with each other, the lever 18 is held at the mating start position relative to the male housing 15. The lever 18 is prevented from rotating to the mating completion position by the locking action of the initial lock portions 58 on the inner surfaces of the locking recessed portions 51. As shown in FIGS. 3 and 9, when the lever 18 is at the mating start position, the operation portion 55 is positioned on the front end side of the connector 10, and the entrances of the cam grooves 57 face the front. The moving plate 17 is disposed at the initial position relative to the male housing 15. As shown in FIG. 9, the plate-side cam pins 65 respectively enter the entrances of the cam grooves 57.

When the moving plate 17 is at the initial position, the front end portions of the tabs 44 of the male terminal fittings 16 are inserted into the through holes 68 by being guided by the expansion inclined surface portions 76. As shown in FIG. 9, the front end portion of each tab 44 is inserted into the through hole 68, and is disposed to extend through the rear protruded portion 92, the plate body 61, and the front protruded portion 69 in the front-rear direction. An end surface portion of the furthermost leading end of the front end portion of the tab 44 (hereinafter, referred to as a “leading end 44A”) is inserted into the straight hole portion 79, at a position rearward of the front end of the front protruded portion 69, and does not protrude forward beyond the front protruded portion 69.

When the moving plate 17 is at the initial position, there is the possibility that the position of the leading end 44A of the tab 44 may change inside the through hole 68 from the initial position due to the assembly tolerance for attaching the moving plate 17 to the male housing 15 or the assembly tolerance for attaching the male terminal fitting 16 to the male housing 15, or due to a rearward pulling force acting on the male terminal fitting 16. In contrast, in the first embodiment, settings are made such that the leading ends 44A of the tabs 44 are always accommodated in the respective through holes 68 when the moving plate 17 is at the initial position, even in consideration of tolerance. For example, even when the leading ends 44A of the tabs 44 are positioned rearward of the plate body 61 as indicated by the dashed double-dotted line in FIG. 9, the leading ends 44A of the tabs 44 are respectively accommodated in the recess portions 93 of the rear protruded portions 92. For this reason, it is possible to avoid a situation where the leading ends 44A of the tabs 44 come loose rearward from the through holes 68.

From the above state, the partner connector 11 is inserted into the hood portion 38. When the partner connector 11 reaches a position where the female mating surface 32 of the female housing 13 comes into contact with the front surface of the plate body 61, the front protruded portions 69 are mated with the opening peripheral surface portions 33 of the female housing 13. At this time, the inclined surface portions 75 of the front protruded portions 69 are disposed along the corresponding opening peripheral surface portions 33 of the female housing 13. The female mating surface 32 of the female housing 13 faces the front surface of the plate body 61 in a surface contactable manner. The straight hole portions 79 and the tab insertion holes 31 are aligned coaxially in the front-rear direction such that the height positions of the inner surfaces of the straight hole portions 79 and the tab insertion holes 31 are aligned without any difference in level (see FIG. 10). The front end portions of the tabs 44 respectively enter the tab insertion holes 31 of the female housing 13.

When the partner connector 11 is inserted into the hood portion 38, the housing-side cam pins 23 and the plate-side cam pins 65 of the moving plate 17 are joined together and inserted into the entrance of the cam grooves 57. In addition, the unlocking portions 24 of the female housing 13 are inserted into the through recessed portions 64 of the moving plate 17 and the locking recessed portions 51 of the hood portion 38. The initial lock portions 58 come into contact with the unlocking portions 24 and are elastically deformed, thereby unlocking the locking recessed portions 51. Accordingly, the lever 18 becomes rotatable toward the mating completion position.

As the lever 18 is rotated toward the mating completion position, the housing-side cam pins 23 and the plate-side cam pins 65, which are in a joined state, move along the groove surfaces of the cam grooves 57. The partner connector 11 and the connector 10 are mated with each other with a low mating force by the cam action of the lever 18. With the rotation of the lever 18, the partner connector 11 and the moving plate 17 move toward the male mating surface 46. In this process, the tabs 44 are disposed in the female cavities 25 from the through holes 68 through the tab insertion holes 31, and are inserted into the connection portions 26 of the female terminal fittings 14 housed in the female cavities 25.

When the lever 18 reaches the mating completion position, the moving plate 17 also reaches a mating position, and the connector 10 and the partner connector 11 are properly mated to each other. As shown in FIG. 10, when the lever 18 is at the mating completion position, the operation portion 55 is positioned at the rear end portion of the connector 10, and the plate-side cam pins 65 and the housing-side cam pins 23 reach the back end side of the cam grooves 57. At this time, the lock arm 59 is locked with the lever lock portion 53, and thereby the lever 18 is held at the mating completion position relative to the male housing 15.

As shown in FIG. 10, when the moving plate 17 is at the mating position, the plate body 61 is sandwiched between the male mating surface 46 of the male housing 15 and the female mating surface 32 of the female housing 13 in the front-rear direction. The front surface of the plate body 61 comes into surface contact with the female mating surface 32, and the rear surface of the plate body 61 comes into surface contact with the male mating surface 46. The tabs 44 are inserted into the connection portions 26 at a proper depth, and the female terminal fittings 14 and the male terminal fittings 16 are electrically connected in a proper state, respectively. Front portions of the tabs 44 respectively come into contact with the elastic contact pieces 28 of the connection portions 26. Rear portions of the tabs 44 are positioned along the front-rear direction in an area extending from the straight hole portions 79 of the through holes 68 to the tab insertion holes 31, respectively. The narrowing portion 81 of each male terminal body 43 is disposed along the expansion inclined surface portions 76 inside the recess portion 93. Furthermore, when the moving plate 17 is at the mating position, each rear protruded portion 92 is mated with the corresponding receiving recessed portion 91 from the front.

As described above, the connector 10 according to the first embodiment includes the housing body 36, the male terminal fittings 16 that are housed in the housing body 36, the tubular hood portion 38 that protrudes forward beyond the housing body 36, and the moving plate 17 that is movable rearward from the initial position to the mating position inside the hood portion 38. The moving plate 17 includes the plate body 61 whose plate surfaces face the front-rear direction, the protruded portions 69 and 92 protruding from the plate surfaces of the plate body 61, and through holes 68 extending through the plate body 61 and the protruded portions 69 and 92. The male terminal fittings 16 include the tabs 44 that extend in the front-rear direction and are inserted into the corresponding through holes 68, respectively. Settings are made such that the leading ends 44A of the tabs 44 are always accommodated in the respective through holes 68 when the moving plate 17 is at the initial position.

With the above configuration, it is possible to maintain a state where the leading ends 44A of the tabs 44 are accommodated in the through holes 68 while the male terminal fittings 16 are housed in the housing body 36, and thus it is possible to increase the reliability of the moving plate 17 protecting the tabs 44. Particularly, the length in the front-rear direction of the through holes 68 can be increased by an amount corresponding to the protruded portions 69 and 92 provided on the moving plate 17, compared with a case where the plate body 61 is not provided with such protruded portions, and thus it is possible to reliably realize a state where the leading ends 44A of the tabs 44 are always accommodated in the through holes 68.

In addition, in the first embodiment, the plate body 61 has a shape that is longer in the left-right direction than in the up-down direction. A plurality of through holes 68 are aligned in the up-down direction and the left-right direction in front view and rear view of the plate body 61. The protruded portions 69 and 92 are provided in correspondence with the through holes 68 aligned in the left-right direction in a vertical intermediate portion of the plate body 61. Thus, the protruded portions 69 and 92 can make the vertical intermediate portion of the plate body 61 thick, and, for example, it is possible to prevent a lateral intermediate portion of the plate body 61 from bulging as a result of warping and deforming in a high-temperature environment or the like.

In addition, in the first embodiment, the rear protruded portions 92 have a shape extending continuously in the left-right direction in such a manner as to couple through holes 68 adjacent in the left-right direction on the rear surface side of the plate body 61. Accordingly, the vertical intermediate portion of the plate body 61 is more firmly reinforced by the rear protruded portions 92. Particularly, when the moving plate 17 is at the mating position, the rear protruded portions 92 are mated with the receiving recessed portions 91 that are open in the male mating surface 46 of the housing body 36. For this reason, the distance between the male mating surface 46 of the male housing 15 and the female mating surface 32 of the female housing 13 can be kept within the thickness of the plate body 61, and it is possible to satisfy the effective contact length between the male terminal fittings 16 and the respective female terminal fittings 14.

Furthermore, in the first embodiment, the housing body 36 includes the male cavities 42 that house the male terminal fittings 16, and the abutment portions 89 provided on the male mating surface 46 side (front surface side) of the housing body 36. The male terminal fittings 16 include the abutted portions 83 that oppose the abutment portions 89 from the rear in a state of being housed in the male cavities 42. The abutment portions 89 are provided in portions in the circumferential direction of the opening edge portion of each male cavity 42 (in the first embodiment, upper end portions of the male cavity 42) on the male mating surface 46 side of the housing body 36. The receiving recessed portion 91 is provided in another portion in the circumferential direction of the opening edge portion of the male cavity 42 (in the first embodiment, the portion excluding the upper end portion of the male cavity 42) on the male mating surface 46 side of the housing body 36.

With the above configuration, the abutment portions 89 can suppress forward movement of the male terminal fitting 16 housed in the male cavity 42. Particularly, the receiving recessed portion 91 and the abutment portions 89 are formed by dividing the opening edge portion of the male cavities 42 in the circumferential direction, and thus the rear protruded portion 92 can be mated with the receiving recessed portion 91 without changing the housing position of the male terminal fitting 16 in the front-rear direction from the existing position. In addition, on the front surface side of the housing body 36, it is possible to form the receiving recessed portions 91 and the abutment portions 89 in a space-efficient manner.

### Other Embodiments of Present Disclosure

The embodiment disclosed herein is an example in all respects and should not be interpreted as limiting in any manner.

In the first embodiment above, the female housing 13 is configured to be separable into the female frame 19 and the female inner housing 21. In contrast, according to another embodiment, the female housing may have an integral and non-separable housing structure.

In the first embodiment above, the male housing 15 is configured to be separable into the male frame 35 and the housing body 36. In contrast, according to another embodiment, the male housing may have an integral and non-separable housing structure, and be constituted by a housing body including male cavities and a hood portion that protrudes from the housing body.

In the first embodiment above, the protruded portions are composed of the front protruded portions 69 and the rear protruded portions 92. In contrast, according to another embodiment, the protruded portions may be composed of either front protruded portions or rear protruded portions.

In the first embodiment above, the plurality of rear protruded portions 92 are provided in correspondence with some of the through holes 68 on the rear surface side of the plate body 61. In contrast, according to another embodiment, a plurality of rear protruded portions may be provided in correspondence with all of the through holes on the rear surface side of plate body.

In the first embodiment above, the plurality of rear protruded portions 92 have a shape continuously extending in the left-right direction on the rear surface side of the plate body 61, in such a manner as to collectively cover the through holes 68 aligned in the left-right direction. In contrast, according to another embodiment, a plurality of rear protruded portions may be provided individually in correspondence with respective through holes similarly to the front protruded portions.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing body; male terminal fittings that are housed in the housing body; a tubular hood portion protruding forward beyond the housing body; and a moving plate that is movable rearward from an initial position to a mating position inside the hood portion,
wherein the moving plate includes: a plate body whose plate surfaces face a front-rear direction; protruded portions protruding from at least one surface out of the plate surfaces of the plate body; and through holes extending through the plate body and the protruded portions,
the male terminal fittings include tabs extending in the front-rear direction and are inserted into the through holes, and
settings are made such that leading ends of the tabs are accommodated in the through holes when the moving plate is at the initial position.

2. The connector according to claim 1,
wherein the plate body has a shape that is longer in a left-right direction than in an up-down direction, a plurality of the through holes are aligned vertically and laterally in front view and rear view of the plate body, and the protruded portions are provided in correspondence with at least through holes aligned in the left-right direction in a vertical intermediate portion of the plate body, from among the plurality of through holes.

3. The connector according to claim 2,
wherein the protruded portions include portions continuously extending in the left-right direction to couple adjacent through holes.

4. The connector according to claim 1,
wherein the protruded portions include rear protruded portions protruding from a rear surface of the plate body, and
a front surface of the housing body includes receiving recessed portions that are mated with the rear protruded portions when the moving body is at the mating position.

5. The connector according to claim 4,
wherein the housing body includes: male cavities that house the male terminal fittings and abutment portions provided on a front surface side of the housing body,
the male terminal fittings include abutted portions that oppose the abutment portions from the rear in a state of being housed in the male cavities,
each of the abutment portions is provided at a portion in a circumferential direction of an opening edge portion of the male cavity in the front surface of the housing body, and
each of the receiving recessed portions is provided at another portion in the circumferential direction of the opening edge portion of the male cavity in the front surface of the housing body.
